(19) United States
(12) Patent Application Publication
(10) Pub. No.: US 2024/0203214 A1
(43) Pub. Date: Jun. 20, 2024

(54) Mounted Customer Service System with Integrated Media Processing Device

(71) Applicant: ZEBRA TECHNOLOGIES CORPORATION, Lincolnshire, IL (US)

(72) Inventors: Anders Gustafsson, Lincolnshire, IL (US); Edward Barkan, Miller Place, NY (US); Darran Michael Handshaw, Sound Beach, NY (US)

(21) Appl. No.: 18/083,234

(22) Filed: Dec. 16, 2022

(51) Int. Cl. G07G 1/00

(52) U.S. Cl. CPC G07G 1/0045

(57) ABSTRACT

Systems and methods are disclosed for providing customer initiated services to a mounted user interface device in a retail environment. At a user interface device, a customer scans an object missing a barcode or label, and the interface device connects to a remote customer service platform configured to detect the object and return to the interface device barcode data for the object, where a corresponding label is printed with the returned data. The user interface device may be automatically connected to a remote agent based on anonymized user data or based on scanned object data for providing particularly customized user services, such as explanations on how to use the object.

### BACKGROUND

As retail environments evolve, customers are increasingly presented with automated, interactive experiences. Self-checkout stations, for example, are available in many retail establishments, providing checkout efficiency and lessening burdens on personnel. More recently, some retailers have deployed interaction stations on the retail floor that allow customers to perform directed actions, such as scanning a product barcode to check the price. These interaction stations may contain a simple barcode (1D barcode, 2D barcode, etc.) scanner or, in some instances, a display and scanner. But, while the idea of such stations in a retail environment is known, to date little has been done to improve the customer's experience beyond scanning an item to provide a price check.

There is a need to provide customers with a more interactive user experience that provides customized services and information to them, and that allows retailers to make available some personnel-level information to customers while freeing up personnel to handle more demanding needs.

### SUMMARY

In an embodiment, the present invention is a system including: an imaging camera having a field of view (FOV); a media processing device; a housing having a display and positioning the imaging camera; and a processor configured to; obtain image data captured from the imaging camera and detect a presence of an object in the image data; in response to failing to obtain a presence of a decodable indicia for the object; perform an object identification process from the image data to determine object identification data; communicate the object identification data to an object identification module with a request for object indicia data corresponding to the object identification data, and in response to receiving the object indicia data from the object identification module, communicate a media processing instruction to the media processing device communicatively coupled to the processor, wherein the media processing device is configured to process media for the object, the media including the object indicia data, in response to receiving the media processing instruction from the processor.

In a variation of this embodiment, the processor is further configured to: display instructions for applying the media to the object.

In a variation of this embodiment, the processor is further configured to: display an indication on display for confirmation of placement of the media on the object; obtain subsequent image data captured from the imaging camera and detect, in the subsequent image data, a presence of the media on the object; and in response to failing to detect a presence of the media on the object, generating a failed object scan indication.

In a variation of this embodiment, the processor is further configured to: communicate the failed object scan indication to a supervisor computing system or a point-of-sale computing system.

In a variation of this embodiment, the object indicia data includes a decodable indicia corresponding to the object identification data and (i) a picture of a representative object corresponding to the object identification data, (ii) user readable information corresponding to the object identification data, (iii) user readable operating instructions corresponding to the object identification data, (iv) machine readable information corresponding to the object identification data, and/or (v) machine readable operating instructions corresponding to the object identification data.

In a variation of this embodiment, the processor is further configured to: detect in the image data captured from the imaging camera a user identification data; and include with the media processing instruction to the media processing device the user identification data, wherein the media processing device is configured to process the media for the object, the media including the object indicia data and the user identification data.

In a variation of this embodiment, the media processing device is a printer.

In a variation of this embodiment, the processor is further configured to examine the image data for a presence of the decodable indicia on the object.

In a variation of this embodiment, the processor is further configured to receive a user input of the decodable indicia on the object.

In another embodiment, the present invention is a system including: a mountable user interface device comprising: an imaging camera having a field of view (FOV); a housing having a display, the housing positioning the imaging camera to extend the FOV in front of the display; and a first processor configured to; obtain image data captured from the imaging camera and corresponding to the FOV, detect a presence of a user in the image data and determine user data identifying the user and/or detect a presence of an object in the image data and determine object data identifying the object, determine, from the user data and/or from the object data, routing data, and communicate the routing data to an external computing system over a communication network; and the external computing system communicatively coupled to the mountable user interface device via the communication network, the external computing system comprising: a second processor configured to: in response to receiving the routing data, determine an object specific data service and/or an user specific data service; configure the object specific data service and/or the user specific data service based on the routing data; and communicate the configured object specific data service and/or the configured user specific data service to the first processor of the mountable user interface device; the first processor further configured to: in response to receiving the configured object specific data service and/or the configured user specific data service, displaying the configured object specific data service and/or the configured user specific data service on the display.

In a variation of this embodiment, the object specific data service and/or the user specific data service comprises a remote user service session with an operator associated with the external computing system.

In a variation of this embodiment, the second processor is further configured to configure the object specific data service and/or the user specific data service based on the routing data by assigning the operator among a plurality of operators based on the user data.

In a variation of this embodiment, the second processor is further configured to configure the object specific data service and/or the user specific data service based on the routing data by assigning the operator among a plurality of operators based on the object data.

In a variation of this embodiment, the object specific data service and/or the user specific data service comprises a predetermined video, image, or message.

In a variation of this embodiment, the first processor is further configured to: instruct the imaging camera to capture the image data in response to a failed object scan event.

In a variation of this embodiment, the failed object scan event is detected at an imaging station of transaction computing device communicatively coupled to the system, and wherein the first processor is further configured to: capture subsequent image data at the imaging camera; detect a successful object scan event at the imaging camera; and communicate the successful object scan event to the transaction computing device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A-1C depict a mounted user interface device having a housing, a display, and an imaging camera showing the device from different orientations, respectively, in accordance with embodiments described herein.

FIG. 2 is a block diagram of an example logic circuit for implementing example systems/devices and methods and/or operations described herein including providing customer initiated services to the user interface device of FIGS. 1A-1C, in accordance with embodiments described herein.

FIG. 3 is a flowchart representative of an example method for providing customer initiated services as may be performed by the example logic circuit of FIG. 2, in accordance with embodiments described herein.

FIG. 4 is a block diagram of another example logic circuit for implementing example systems/devices and methods and/or operations described herein including routing customer or object specific services to the user interface device of FIGS. 1A-1C, in accordance with embodiments described herein.

FIG. 5 is a flowchart representative of an example method for routing specific services to the user interface device as may be performed by the example logic circuit of FIG. 4, in accordance with embodiments described herein.

FIG. 6 a block diagram of an example user interface for implementing example methods and/or operations described herein, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, customers are increasingly presented with interaction stations in retail environments. A common example is a self-checkout station designed for completion of a transaction. Some retailers now deploy interaction stations on the retail floor, stations that allow customers to perform actions, such as scanning a product barcode to check the price. These interaction stations may contain a simple barcode (QR code, etc.) scanner or, in some instances, a display and scanner. However, to date, these stations provide limited features and do not provide features tailored to the customer or specific to a product. Further, these interaction stations have limited interaction with backend computing systems, such as servers, limiting the availability of features that can be provided to a customer.

Therefore, it is an objective of the present disclosure to provide systems and methods capable of providing customer-initiated services to a user interface device on a retail floor, allowing the customer to receive object specific media or customer specific media. It is a further objective of the present disclosure to provide systems and methods capable of identifying and routing specific services to that user interface device. As a result, customers, retail personnel, or other users are provided with next generation customer service on the retail floor, without needing to interact directly with retail personnel, but rather through their own initiated request and resolved in coordination with backend systems configurable by the retailer to optimize customer service offerings.

In some examples, it is an objective of the present disclosure to provide systems and methods capable of providing next generation customer service. Example systems may include a housing having an imaging camera with field of view (FOV) and a media processing device that may or may not be within that housing or coupled thereto, but both the housing the media processing device are mounted for user interaction. The system may include one or more processors that are able to obtain image data captured from the imaging camera and detect a presence of an object in the image data. The processor(s), in response to failing to obtain a presence of a decodable indicia for the object, may perform an object identification process from the image data to determine object identification data and communicate the object identification data to an object identification module with a request for object indicia data corresponding to the object identification data. Further the processor, in response to receiving the object indicia data from the object identification module, may communicate a media processing instruction to the media processing device communicatively coupled to the processor, and that media processing device may provide a media to a user, where that media may be a printed media, a video media displayed to the user, an audio only media, some combination thereof, or other media.

In some examples, the processor(s) may determine, from a user data and/or from an object data, routing data that is communicated to an external computing system. That external system, in response to receiving the routing data, may determine an object specific data service and/or a user specific data service this to be provided to the user. The external system therefore may provide such specific services to the media processing device.

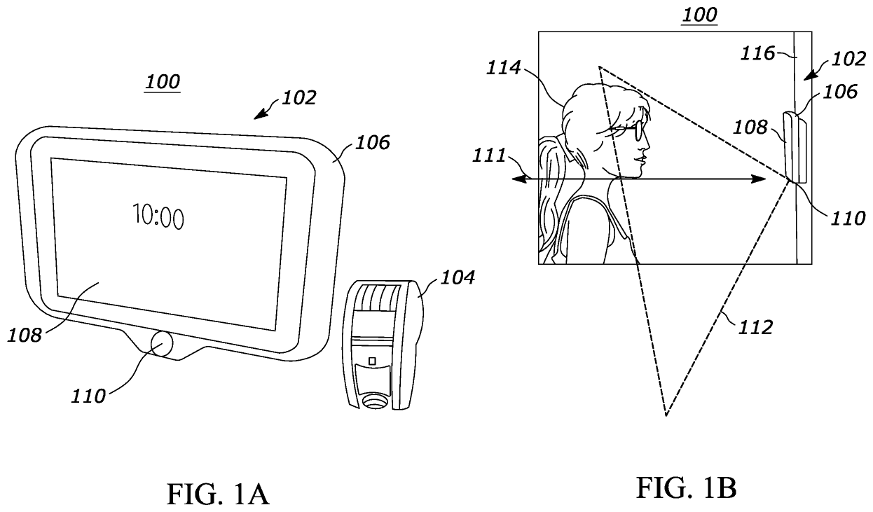

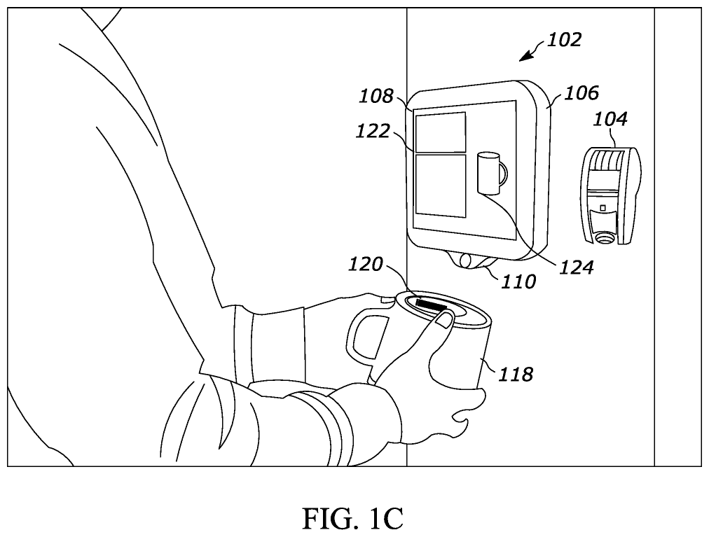

FIGS. 1A-1B depict an interface station 100 as part of a customer service system, in accordance with various examples herein. The interface station 100 includes a user interaction device 102 and a media processing device 104. The interaction device 102 includes a mountable housing 106 and a digital display 108 surrounded, at least partially by the housing 106. The interaction device 102 further includes an imaging camera 110 configured to capture image data over a field of view (FOV) 112. That FOV 112 may be designed so as to capture a user 114 standing within a vicinity of the interface station 100. As shown in FIG. 1B, in some examples, the imaging camera 110 defines a wide FOV 112 that extends above and below a horizontal plane 111 a sufficient amount in both directions to capture, within image data, a common-height (e.g., 150 cm to 195 cm) user's face and a common-height user's hands or items the user is holding in their hands. The housing 106 is shown mountable to a wall 116. But, in various examples, the housing 106 may be mountable to any number of vertical surfaces, including that of a mobile robot. Further, the housing 106 may be mountable to any number of horizontal surfaces, such as tabletop countertop. In some such examples, a housing may be formed to have the display tilting upwards toward a user for the user to see and interact with the display. As used herein, interaction refers to the user being able to see interactive information displayed on the display 108 and have the imaging camera 110 capture image data corresponding to the user 114, e.g., captured image data that includes at least a portion of the user or at least a portion an item with the user. An interaction with the device 102 initiates customer service operations, for example, in response to the device 102 detecting a presence of the user within a predetermined vicinity.

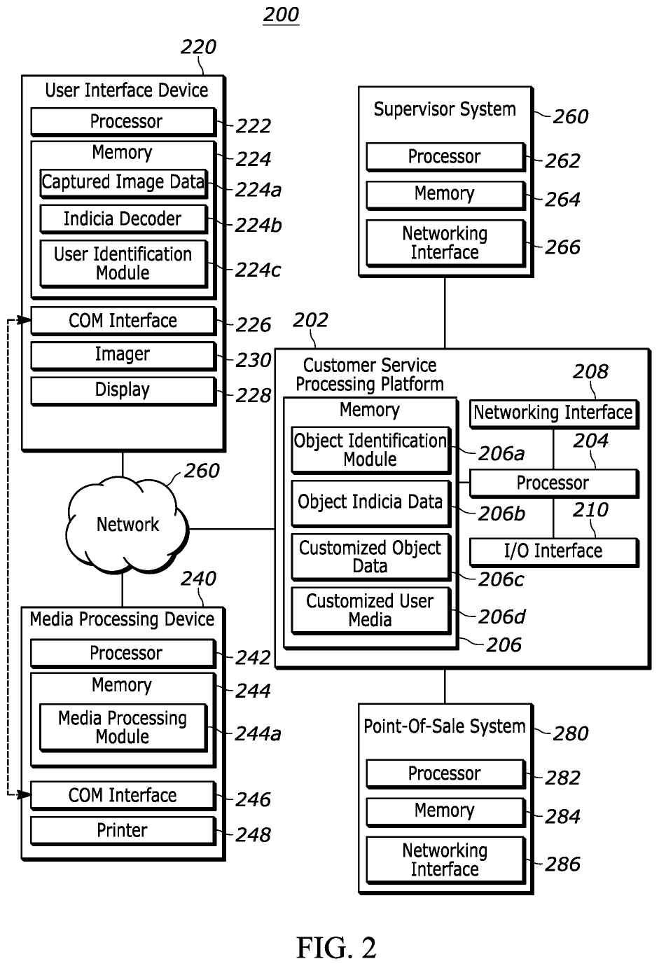

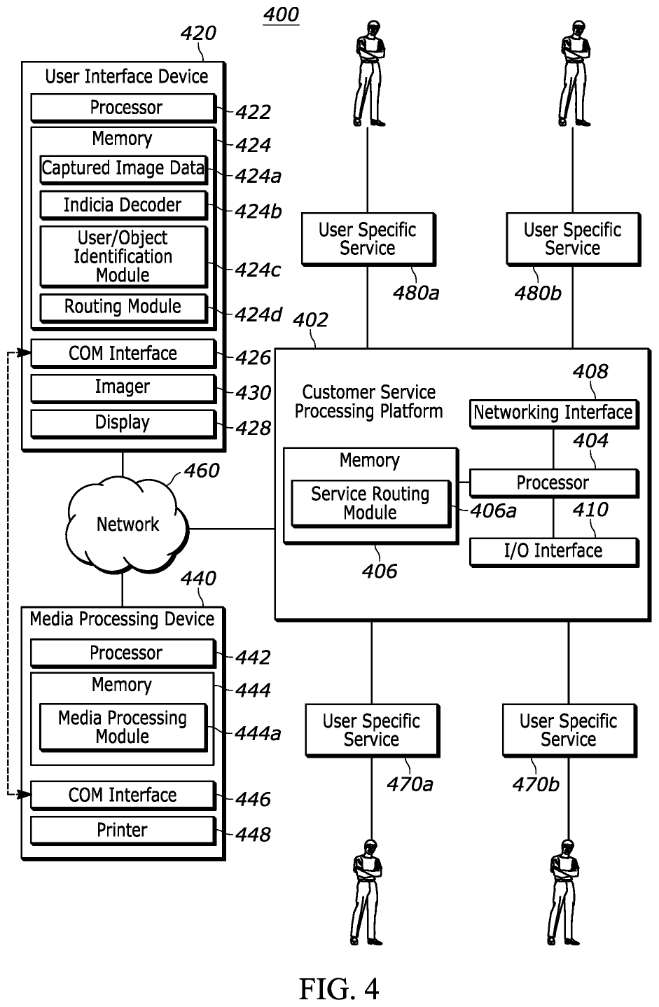

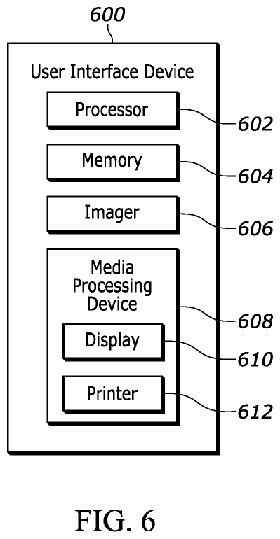

As shown in the example of FIG. 1A, the media processing device 104 may be a standalone device separate from the housing 106 (e.g., FIGS. 2 and 4). Although, in some examples, the media processing device and imaging camera may be integrated into the same housing (e.g., FIG. 6). The media processing device 104 may be coupled to the housing through a communication interface, such as a cable or a wireless connection such as WiFi or Bluetooth. The media processing device 104 is illustrated as a printer device, for example, a label printer. As shown in FIG. 6, the media processing device may be integrated into the housing of the interaction device. In some examples, the media processing device may be an RFID printer (e.g., a printer that processes labels with RFID tags by encoding data into the RFID tags and optionally printing visible data), a bracelet printer, a loyalty card printer, a coupon printer, or other media processing device.

FIG. 1C illustrates an example operation of the interface station 100, in which the user 114 has carried an item 118 up to and within the FOV (not shown) of the imaging camera 110 and interface station 100 scans a barcode 120 and displays item specific information, which in this example includes image indicia data 122 (e.g., a price, name, and barcode) corresponding to the item 118 and a picture of the item 124. While the example of FIGS. 1A-1C may be described as pertaining to a retail environment, more generally the interface station 100 may be deployed in any of a variety of environments including a warehouse facility, a distribution center, etc. As used herein, the words “barcode”, “indicium”, and “indicia” should be understood as being synonymous. As such, a barcode, indicium, or indicia as used herein should be viewed as any visual feature that encodes a payload by way of some encoding scheme. A barcode, as used herein, may include, but isn't limited to, 1D barcodes, 2D barcodes, 3D barcodes, as well as QR codes, etc.

FIG. 2 is a block diagram representative of an example logic circuit capable of implementing example methods and/or operations described herein. As an example, the logic circuit may be capable of implementing one or more components of FIGS. 1A-1C and 6. FIG. 2 illustrates an example system 200 for providing customer service operations. More specifically, an example logic circuit is shown of a customer service processing platform 202, user interface device 220, and media processing device 240 collectively capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs). In the illustrated example, the processing platform 202 is a network accessible processing platform communicatively coupled to the user interface device 220 and the media processing device 240 through a communication network 260. The user interface device 220, in some examples, may be implemented within the housing 106 of FIG. 1, and the media processing device 240 implemented as the media processing device 104.

In the illustrated example, the customer service processing platform 202 includes a processor 204 such as, for example, one or more microprocessors, controllers, and/or any suitable type of processor. The example processing platform 202 includes memory (e.g., volatile memory, non-volatile memory) 206 accessible by the processor 204 (e.g., via a memory controller). The example processor 204 interacts with the memory 206 to obtain, for example, machine-readable instructions stored in the memory 206 corresponding to, for example, the operations represented by the flowcharts of this disclosure. The memory 206 includes an object identification module 206a, object indicia data 206b, customized object data 206c, and customized user media 206d, each of which are accessible by the example processor 204. While shown separately, in some examples, the applications 206a, 206b, 206c, and 206d (discussed further below) may be executed in the same application.

The example processing platform 202 includes a networking interface 208 to enable communication with the other machines and systems via, for example, one or more networks, such as network 260, or connected directly thereto. The example networking interface 208 includes any suitable type of communication interface(s) (e.g., wired and/or wireless interfaces) configured to operate in accordance with any suitable protocol(s) (e.g., Ethernet for wired communications and/or IEEE 802.11 for wireless communications). The example processing platform 202 also includes input/output (I/O) interfaces 210 to enable receipt of user input and communication of output data to the user. Such user input and communication may include, for example, any number of keyboards, mice, USB drives, optical drives, screens, touchscreens, etc.

As stated, the user interface device 220 may be contained within a mountable housing like that of housing 106 of the interface station 100 in FIGS. 1A-1C. In the illustrated example, the user interface device 220 includes a processor 222, a memory 224, communication interface 226, a display 228, and an imager 230 (e.g., a two-dimensional (2D) imaging camera, including a color imager, a three-dimensional (3D) imaging camera, etc.). The user interface device 220 may be directly connected, for example, through a wired connection via the communication interface 226, to the media processing device 240. The media processing device 240 may include a processor 242, a memory 244, a communication interface 246, and a printer 248. The devices 220 and 240 may be communicatively coupled to one another and at least one (and in some examples both) are communicatively coupled to the platform 202 through the network 260.

The user interface device 220 and the media processing device 240 may each include flash memory used for determining, storing, or otherwise processing data corresponding to customer service operations described herein.

In the illustrated example, the memory 224 includes image data 224a captured by the imager 230, an indicia decoder 224b for decoding indicia identified in captured image data, and user identification module 224c. As discussed in example processes and methods herein, the captured image data may be communicated to the customer service processing platform 202 for analysis. In some examples, the indicia decode 224b represents computer executable instructions for identifying and decoding indicia in the image data and, in some examples, identifying and communicating other object identification features in the captured image data, which may be communicated to the processing platform 202. The user identification module 224c may represent computer executable instructions for identifying user identification data in the image data 224a. In some examples, to comply with local requirements regarding the privacy of user derived data, the user identification module 224c may be locked at the user interface device 220 and prevented from communicating obtained user identification data to the processing platform 202. In some examples, the module 224c performs an anonymization on the user identification data before communicating it to the processing platform 202, so that person specific identification data is stripped out from the user identification data. In yet other examples, the user identification module 224c may be configured to transmit the entire user identification data to the processing platform 202. In various example, identification may be performed to the extent that necessary to make a match to another person without regard to the actual identity of the person or determining their actual identity.

The memory 244 includes a media processing module 244a that may receive a media processing instruction communicatively coupled to it directly from the processing platform 202 through the network 260 or via the connection between communication interfaces 226 and 246. As described further below, the media processing device may then process media corresponding to the object based on that instruction, including, for example, printing a label for a user with the printer 248.

In the illustrated example, the processing platform 202 is further connected to a supervisor computing system 260 and/or a point-of-sale system 280. A supervisor system may include a system accessible by a supervisor or administrative personnel, and more generally refers to any external computing system that can provide partially- or fully-automated data assistance or data oversight. The supervisor computing system 260 includes a processor 262, memory 264, and a networking interface 266. The point-of-sale system 280 includes a processor 282, memory 284, and a networking interface 286.

Each of the one or more memories 206, 224, 244, 264, and 284 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 204, 222, 242, 262, and 282 (e.g., working in connection with the respective operating system in the one or more memories 206, 224, 244, 264, and 284) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 206, 224, 244, 264, and 284 may store an operating system (OS) (e.g., Microsoft Windows, Linux, UNIX, etc.) capable of facilitating the functionalities, apps, methods, or other software as discussed herein. The one or more memories 206, 224, 244, 264, and 284 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a task management application, UI management application, etc., configured to facilitate various functionalities discussed herein.

The one or more processors 204, 222, 242, 262, and 282 may be connected to the one or more memories 206, 224, 244, 264, and 284 via a computer bus responsible for transmitting electronic data, data packets, or otherwise electronic signals to and from the one or more processors 204, 222, 242, 262, and 282 and one or more memories 206, 224, 244, 264, and 284 to implement or perform the machine readable instructions, methods, processes, elements or limitations, as illustrated, depicted, or described for the various flowcharts, illustrations, diagrams, figures, and/or other disclosure herein.

The one or more processors 204, 222, 242, 262, and 282 may interface with the one or more memories 206, 224, 244, 264, and 284 via the computer bus to execute the operating system (OS). The one or more processors 204, 222, 242, 262, and 282 may also interface with the one or more memories 206, 224, 244, 264, and 284 via the computer bus to create, read, update, delete, or otherwise access or interact with the data stored in the one or more memories 206, 224, 244, 264, and 284 and/or external databases (e.g., a relational database, such as Oracle, DB2, MySQL, or a NoSQL based database, such as MongoDB). The data stored in the one or more memories 206, 224, 244, 264, and 284 and/or an external database may include all or part of any of the data or information described herein, including, for example, task data, data elements for display in UI and/or other suitable information.

The networking interfaces 208, 266, and 286, as well as communication interface 226 (and in some examples communication interface 246) may be configured to communicate (e.g., send and receive) data via one or more external/network port(s) to one or more networks or local terminals, such as network 260, described herein. In some embodiments, these networking and com interfaces may include a client-server platform technology such as ASP.NET, Java J2EE, Ruby on Rails, Node.js, a web service or online API, responsive for receiving and responding to electronic requests. The networking interfaces 208, 266, and 286 and/or the communication interfaces 226 and 246 may implement the client-server platform technology that may interact, via the computer bus, with the one or more memories 206, 224, 244, 264, and 284 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 208, 266, and 286 and/or the communication interfaces 226 and 246 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 260 or through direct device to device communication in some embodiments. In some embodiments, network 260 may comprise a private network or local area network (LAN). Additionally, or alternatively, network 260 may comprise a public network such as the Internet. In some embodiments, the network 260 may comprise routers, wireless switches, or other such wireless connection points communicating to the processing platform 202 (via the networking interface 208), the user interface device 220 (via the communication interface 226), and the media processing device 240 (via the communication interface 246) via wireless communications based on any one or more of various wireless standards, including by non-limiting example, IEEE 802.11a/b/c/g (WIFI®), the BLUETOOTH® standard, or the like.

The I/O interface 210 may include or implement operator interfaces configured to present information to an administrator or operator and/or receive inputs from the administrator or operator. The displays 228 may be connected to an I/O interfaces (not shown) in user device 220. A user interface may be provided on the display screen which a user/operator may use to visualize any images, graphics, text, data, features, pixels, and/or other suitable visualizations or information. For example, the device 220 may comprise, implement, have access to, render, or otherwise expose, at least in part, a graphical user interface (GUI) for displaying images, graphics, text, data, features, pixels, and/or other suitable visualizations or information on the display screen. The I/O interface 208 and/or the display 228 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the processing platform 202 and/or the user device 220. The display 220 may be an interactive touchscreen display allowing user input. Further the display 228 may be accompanied by a keyboard or keypad connected through respective I/O interfaces (not shown) in the user device 220. Further still, in some examples the display 228 may be replaced with (or augmented to include) a voice-interaction device, a haptic device, or keypad button interface.

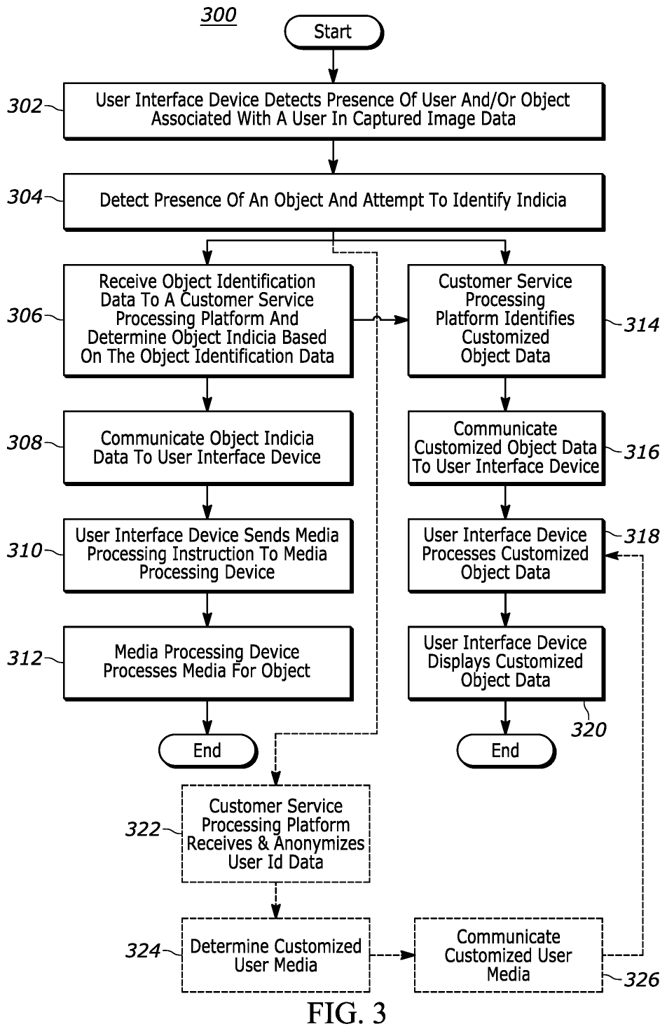

FIG. 3 provides an example process 300 that may be implemented by the system 200. At a block 302, the process 300 begins by a user interface device (e.g., device 220) detecting an initial presence of a user and/or an item associated with a user within a FOV of the interface device. That detection may include detecting that an item (e.g., a user or object) is within the FOV and within a maximum allowed distance from the user interface device (e.g., within 10 feet, 5 feet, 2 feet, or 1 foot) indicating that a user may desire to interact with the device. As an example, detection may be achieved by performing 2D image analysis, 3D image analysis, using a motion sensor, using a proximity sensor, or other technique. In some examples, the block 302 is designed to detect an initial presence of a user, where a user may be identified by capturing image data and performing pattern recognition to identify the likely presence of a person. In some examples, at the block 302, the process 300 detects the initial presence of an object by performing pattern recognition to identify edges, graphics, texts, etc. indicative of the presence of an object. In some examples, the block 302 performs initial user/object presence detection and therefore may only capture a portion of the user/object in the image data. In any event, in the illustrated example, with an initial presence of user/object determined at a block 302, at a block 304, a processor of the user interface device may obtain a series of the captured image data from which the presence of a specific object is then determined. For example, at the block 304, the process 300 may detect the presence of an object by identifying a decodable indicia within the captured image data or by identifying object features (surfaces, outer periphery, and general shape) associated with a particular object. At the block 304, the process 300 may detect a presence of an object, such as an item a person is holding. Additionally, at the block 304, with an object identified, the process 300 attempts to identify an indicia for the object in the captured image data (e.g., at the indicia decoder 224b) and decode that indicia, which would allow the user interface device to generate object identification data locally.

In some examples, the block 304 only detects the object in captured image data and communicates the image data to a remote processing station, such as a customer service processing platform (e.g., platform 202) for analyzing the image data to attempt to identify indicia and decode the same. In some examples, the block 304 detects (at the user interface device) the object and the indicia and further decodes the indicia to determine indicia data (e.g., a payload), which is then sent to an external server, such as a customer service processing platform or other server, that takes the indicia data and determines the object indication data. Similarly, when detecting an object without an indicia, the block 304 detects (at the user interface device) the object and image features of the object, the image data and/or image features may be sent to an external server, such as a customer service processing platform or other server, that takes the indicia data and determines the object indication data.

In any case, in the illustrated example, in response to not detecting the presence of a decodable indicia for the object, a block 306 performs an object identification process on the image data to determine object identification data. For example, if the user interface device cannot find or decode an indicia in the image data, then the user interface device may communicate the image data to the customer service processing platform (e.g., platform 202) that executes an application (e.g., the object identification module 206a), to identify the object. For example, an object indication module may perform image feature identification and analysis and then apply pattern matching to a database of object features to identify the object. In some examples, the object indication module may be a trained machine learning module, such as a convolution neural network (CNN) or other deep learning network, trained to identify objects from input image data. In some examples, block 304 is performed at a user interface device, which identifies some object identification data in the image data and communicates it along with the image data to remote a processing platform having an object identification module (e.g. module 206a) with a request for an object indicia (e.g., from the stored object indicia data 206b) for the object. In some examples, the block 306 may perform such object identification process even though the block 306 has received a decodable indicia for the object. In some examples, at a block 306, object indicia data (e.g., a barcode, QR code, or other decodable indicia) is determined from the object identification data. In some examples, at the block 306, the payload associated with the object is determined, i.e., the payload that is to be encoded into an indicia. The block 306 then communicates the payload to the user interface device which then converts the payload to the corresponding decodable indicia (e.g., the user interface device converts the received payload into the object indicia data). For example, at block 306, the process 300 may determine the payload data (e.g., 1234567890123) and a type of indicia (e.g., UPC) and transmit that data (e.g., via block 308) to the user interface device (acting as an edge device). The user interface device may then encode the 1234567890123 payload into a visual representation as it would appear under with a UPC barcode and print a label with the UPC code on it.

Whether object indicia data, payload data, augmented object indicia data, augmented payload data, or other data associated with identifying the object, at a block 308, the process 300 communicates such data to the user interface device (e.g., device 220), which processes the object indicia data and generates a media processing instruction, at a block 310. The user interface device communicates the media processing instruction(s) to a media processing device (e.g., device 240) through communication link (e.g., through communication interfaces 226, 246) and the media processing device processes the media for the object (at block 312). In the example of a printer as the media processing device, at the block 312, the process 300 may print an adhesive-backed label with the object indicia printed thereon, for the user to apply the label on the object. Thus, via the blocks 302-312, the process 300 allows a user to have an image captured of an object without a decodable indicia, have a remote customer service processing platform identify the object and its corresponding indicia, and communicate indicia data to the user interface station so that media processing device can generate a label to affix to the product. That label, as discussed herein, may include other information in addition to or in place of object indicia data.

In the illustrated example, the process 300 further includes the provision of customized object data, as part of a customer service processing platform feature. For example, at a block 314, the customer service processing platform receives the object identification data from the block 304 and/or from the block 306 (or object indicia data from the block 306) and determines if in addition to the object indicia data, customized object data should be communicated to the user interface device. For example, in response to the object being identified, the process 300 may access stored customized object data (e.g., data 206c) to determine if any applicable customized object data exists corresponding to the object. Such customized object data may be stored media, such as text data, video file data, and/or audio file data associated with the object. For example, the customized object data may be (i) a picture of a representative version of an object corresponding to the object identification data (or object indicia data), (ii) user readable information corresponding to the object identification data (or object indicia data) such as description of the object, (iii) user readable operating instructions corresponding to the object identification data (or object indicia data), (iv) machine readable information corresponding to the object identification data (or object indicia data), and/or (v) machine readable operating instructions corresponding to the object identification data (or object indicia data). The customized object data may be a video explaining how to use the object or a video explaining how to properly label the object with the media provided by the media processing device. The customized object data may be determined by an authorized user of the customer service processing platform 202, and in some examples may be promotional video content for the user. In some examples, object identification data (or indicia) are communicated to an external system that communicates back customized object data. The customized object data may identify related items, alternate items, compatible consumables, accessories that may work with the identified object, etc.

At a block 316, the customer service processing platform communicates the customized object data to the user interface device, which at a block 318, processes the customized object data. In examples where the customized object data are machine readable instructions, the user interface device processes, at the block 318. In examples, where the customized object data is displayable data, at a block 312, the user interface device displays on its display (e.g., display 228) the customized object data, e.g., a representative rendition of the object, a video of how to use the object, a video of how to affixed a printed label to the object, a map of a location of the object in the retail environment, etc.

Optionally, in some examples, the process 300 receives user identification data from the module 224c of the user interface device 220 and uses that data to provide customized user media back to the user. For example, at an optional block 322, the customer service processing platform receives the user identification data from the block 302. To prevent person-identifying data (e.g., data that could be used to specifically identify the particular user), at the block 322, a data anonymization process is performed on the received data. That process strips away and discards any person-identifying data from being stored or used by the customer service processing platform 202 or any systems connected thereto. The block 322 generates anonymized user identification data, data that may include general demographic data about the user or Anthropometric facial measurements, height, emotional condition, etc. That anonymized user identification data is provided to a block 324 that processes that data and determines customized user media that is then communicated, via a block 328, to the user interface device for processing along with the customized object data at the block 318 and displayed on the display of the user interface device, via the block 320. The customized user media may be, for example, video data or image data selected based on the anonymized user data, such as media associated with a certain season for example if a user is detected as wearing certain season-associated attire (e.g., a winter coat or scarf). In some examples, a user interface device may be configured to display, in response to detecting a user, selectable options that allow a user to enter user identification data. For example, the display may be a touchscreen display allowing users to opt in to providing some non-person-identifying data, such as language preference. That data may be communicated to the customer servicing processing platform, which at optional blocks 322-324 may be used to select customized user media, for example, media predetermined as associated with different users of different ages, different genders, different foreign language preferences, different ethnicities, etc.

In any event, in various examples, the system 200 and/or the process 300 may be used in various ways to enhance customer experience. A user interface device on the retail floor may be used, with an inference engine at a remote processing platform, to identify an item and determine its pricing without a barcode or other price indication, thus saving the customer time at checkout. The identity, price, and description may be provided to a user as customized object data displayed on the screen of the user interface device. A barcode or other indicia corresponding to the device may be printed on a label (an example media object) using a media processing device connected to the user interface device, allowing the customer to place the label on the item or take the label to a checkout location. Of course, while an example is described of identifying an item, the process 300 may identify times from their packaging, for example, by having the user interface device capture 2D images of that packaging, sending those 2D images to the remote processing platform to identify the corresponding item.

In various examples, the customized object data may include data attendant to the identified object, for example, using rules configured in the memory 206. For example, in response to the object identification module 206a identifying the object in the captured image data, at the block 314, a coupon rule stored in the memory 206 may be used to identify as customized object data, a coupon offering associated with the object for later redemption as a POS. In some examples, anonymized user data may be used as the block 324 to identify as customized user media a user specific coupon for later redemption as a POS. Thus, if a customer scans an item to check its prices, the user interface device (and media processing device) can offer them a deal on a related item or multiples of the same item while the customer is shopping to promote real-time incentives.

In various examples, the user interface device 220 may be configured to capture image data over its FOV in response to receiving data or an instruction from the customer service processing platform 202. For example, in response to receiving the media processing instructions, the user interface device 220 may capture one or more image data during or after processing of the media object. Such captured image data may then be processed at the user interface device 220 or sent to the remote processing platform 202 for determining if a media object has been presented to the user. If the media processing device is a printer this functionality would allow the system to determine if the printer is working properly and has printed a label. For example, the object identification module 206a may analyze received image data to identify the presence of a label or a label bearing the barcode or other object indicia data. In some examples, in response to the object identification module 206a determining that no label was printed, a customized object data may be sent to the user interface device 220 in the form of a message to be displayed to the customer. Also, a data flag may be sent to the supervisor system 260 indicating that media processing device 240 is not operating properly. In some examples, if the label has printed, but has not been taken by the customer, customized object data may be sent to the user interface device 220 in the form of a message to be displayed to the customer informing them to collect the label. Such remote printer monitoring operations provide advantages to customers and to retail personnel.

Other ways the system 200 and/or the process 300 may be used to enhance customer experience will be apparent. These include finding alternative items to an imaged object. The customer service processing platform 202 may find comparable products to the product recognized by the inference engine. The alternative products may be displayed on the display of the user interface device 220 along with their prices and other information and, in some examples, a visual map to their locations in the retail environment. In some examples, a map or other graphical information may be printed on the label from the media processing device 240.

In addition to sending object indicia, customized object data, anonymized user data, and/or customized user media to the user interface device 220, the customer service processing platform 202 may communicate such data to the supervisor system 260 for data tracking, for indicating to personnel that items lack proper barcodes, for indicating to personnel that a media processing device is not functioning properly, e.g., the printer out of ink or other media, customer emotional state, etc. Further, the customer service processing platform 202 may communicate object indicia, customized object data, anonymized user data, and/or customized user media to the point-of-sale station 280 for indicating that an item with a replacement label may be presented at the POS 280. Toward that end, in some examples, the object indicia data 206b may be combined with customized object data to be printed on a label, so that, for example, a barcode indicia is printed on a label along with a code or marker indicating that the label was generated at a user interface device and not through normal warehousing operations. Such extra code or marker can inform personnel at a point-of-sale location or self-checkout location, that the label was printed and given to the customer.

FIG. 4 illustrates a block diagram representative of another example logic circuit capable of implementing example methods and/or operations described herein. The example logic circuit may be capable of implementing one or more components of FIGS. 1A-1C and 6. In particular, FIG. 4 illustrates an example system 400 for providing customer service operations. Similar to the user interface device 220 in FIG. 2, the example system 400 includes user interface device 420 communicatively coupled to a customer service processing platform 402 through a network 460. The processing platform includes a processor 404, a memory 406, a networking interface 408, and an I/O interface 410. The user interface device 420 includes processor 422, a memory 424, a communication interface 426, an imager 430, and a display 428. In the illustrated example, the communication interface 426 may include a direct communication link to communication interface 446 of a media processing device 440 that also includes a processor 442, a memory 444, and a printer 448. The memory 444, similar to the memory 244 of the media processing device 240 includes a media processing module 444a.

The user interface device 420 and media processing device 440 may perform similar processes and functions as those described in reference to user interface device 220 and media processing device 240, respectively. For example, the memory 424 may include captured image data 424a, an indicia decode 424b, and a user/object identification module 424c.

The user interface device 420, however, is further configured to determine routing specific data that can be used by the customer service processing platform 402 to route specific types of services directly to the user interface device 420, allowing the device to provide services such as live customer service personnel, real time services, and/or predetermined video, image, or message services. Examples of specific routed services include connecting an object specific expert as a remote live attendant appearing on the display 428. That way, if a customer has questions on an item, they could show the item to the camera (e.g., the imager 430) and get immediate remote assistance from someone who can help. For example, CNN-based object identification module (not shown) in the memory 406 may determine the type or category of object appearing in captured image data and get appropriate person for assistance. In this way, someone needing help with a certain type of tool in the hardware store might be paired with a customer service representative that the customer service processing platform 402 identifies as someone with knowledge of that tool or category. This enhances instant remote help at the user interface device by providing the correct person to answer the question instead of just any person available. Another example of specific routed services include customer service follow-up. For example, the customer service processing platform may connect the user interface device to a remote customer service tech or in-store person on mobile computer. The system can further enhance the two-way communication by selecting the appropriate customer service rep, but also by recording facial recognition or anthropometry data of the customer and communicate that data to the appropriate customer service rep's mobile computer. In this way, the service rep can follow up with the customer when they recognize them in another location (e.g., at a point-of-sale or throughout the retail environment) to make sure they found what they were looking for.

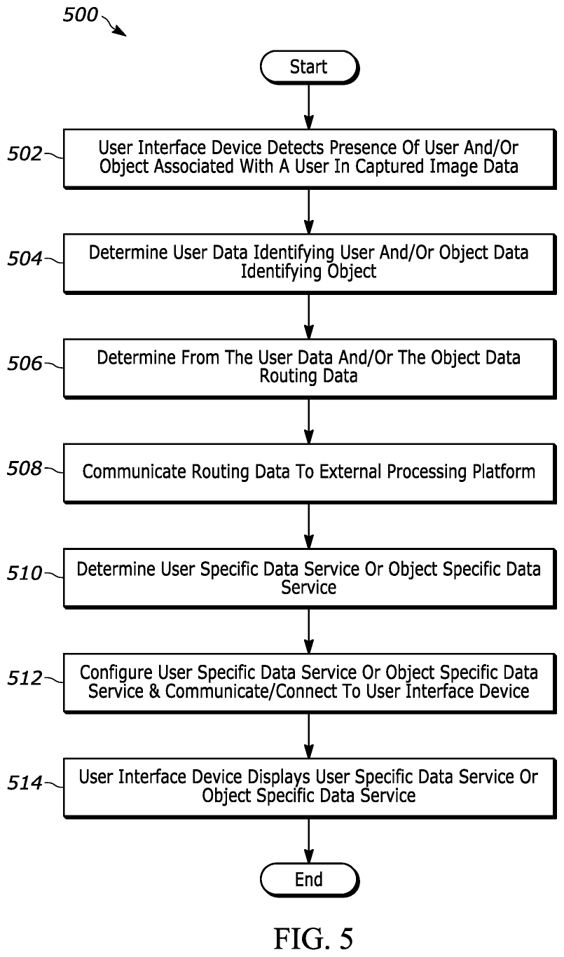

FIG. 5 provides an example process 500 that may be implemented by the system 400. At a block 502, the process 500 captures image data over a FOV of the user interface device 420 and detects the presence of a user and/or object associated with a user. The captured image data is then analyzed to determine, at the user interface device 420, user data identifying the user or object data identifying the object. For example, the user/object identification module 424c may analyze the captured image data and generate anthropometry data on the user or perform other facial recognition processing. For object data, the module 424c may identify object features, such as geometry features of the shape or dimensions of the object or other features such as graphics, indicia, etc. that can identify the object.

At a block 506, the process 500 determines, from the user data and/or object data, routing data that is communicated to an external processing system, such as the customer serving processing platform 402, by a block 508. In the illustrated example, the memory 424 includes a routing module 424d that receives the user data and/or object data and generates the routing data. The routing data may be a decoded indicia of the object, data indicating a failed attempt to decode an indicia of the object, anonymized user data, or other data.

In the illustrated example, the process 500 receives the routing data and processes it to determine, at a block 510, a type of user specific data service or type of object specific data service to access for the user interface device 420. For example, a service routing module 406a may be configured to analyze the routing data and, in response to determining that it identifies an object, the service routing module 406a may determine that one of a number of object specific services 470a/470b are to be accessed to provide a service to the user interface device 420. Or, the service routing module 406a may determine that one of a user specific service 480a/480b should be accessed to provide a service to the user interface device 420. Any of the services 470a, 470b, 480a, and 480b may provide a customer service personnel live feed or other real time services, and/or predetermined video, image, or message services, for example.

At the bock 510, beyond identifying the type of service, the specific service is identified. In identifying a need to route an object specific service, for example, the service routing module 406a may analyze the routing data and determine that an object specific service 470a in the form of a mobile computing device of a personnel expert in operation of the object identified at the user interface device is to be routed to that user interface device. Or the service routing module 406a may determine that the object specific service 470b of a generally-knowledgeable employee or supervisor is to be routed. The object specific services can vary and can provide real time video to personnel, prerecorded video of how to use or operate an object, or other service selected based on the object.

In a similar manner, at a block 510, the service routing module 406a may analyze routing data to select between different user specific services. For example, user specific service 480a may be a computing system of a customer service personnel available to customers that are members of a concierge service offered by the retailer and the user specific service 480b may be a computing system of a customer service personnel who speaks a foreign language identified from the routing data. In these various examples, the customer service processing platform 402 communicates with the selected specific service to establish a connection for routing service to the user interface device 420, either through the customer service processing platform 402 or directly, for example, when the specific service is connected to the network 460 and able to directly communicate with a user interface device. In such later instances, the processing platform 402 may send network address information obtained from the user interface device 420 to the respective selected service for secured direct communication.

In illustrated example, after identifying the specific service, at a block 512, the process 500 configures user specific data or object specific data from the selected service. Such configuration may include modifying the routed data to include information specific to the object or to the person. For example, a video feed may be established with the object specific service 470a and the block 512 may overlay data on the object into that video feed. For the user specific service 480a, the block 512 may overlay data on the concierge program of the user into the video feed or automatic closed captions based on the service person's speech, using a speech recognition engine and/or translation engine at the customer service processing platform.

With the specific data service configured (or with the specific data service un-configured if the block 512 does not perform configuration), the block 512 routes the specific data service to the user interface device, which displays (via block 514) the specific data service on the display 428 for interaction with the customer. For example, the displayed service may be a customer service personnel live feed or other real time services, and/or predetermined video, image, or message services, for example. In some examples, the live feed is a two-way live feed, such that personnel at the user/object specific service receive a video feed from the imager of the user interface device.

In some examples, the selected object specific service or user specific service may send instructions to the customer service processing platform 402 to select one or more of the customized object data and/or customized user media stored there and send that to the user interface device 420 as configured user data or configured object data (at a block 512).

In some examples, the object specific service or user specific service may include an instruction to the user interface device to capture image data using the imager, for example, in response to a determination (at the user interface device 420 or at the customer service processing platform 402) of a failed object scan event. For example, the memory 406 may include an object identification module, object indicia data, customized object data, and customized user media, in a similar manner as to that described in FIG. 2, and the object identification module may determine if a failed object scan event has occurred from analyzing the received image data. In response, the object specific service or user specific service may send, through the processing platform 402, an instruction to capture subsequent image data, which the user interface device may do and then an attempt to detect a successful object scan event. If a successful object scan is detected that success may then be communicated from the user interface device 420 to the customer servicing platform 402 and optionally to the selected user specific service or object specific service. In this way, an object specific service, a user specific service, or the customer service processing platform, may attempt to address an successful object scan by instructing the user interface device to attempt another object scan, for example, after displaying user instructions on its display.

In any of the various examples herein the user interface device may be used in conjunction with a transaction computing device, for example, at a point-of-sale. For example, a successful object scan, either from the initial image data or the subsequent image data, may be communicated to a transaction computing device, such as a point-of-sale system (e.g., point-of-sale system 280) which may then register the successful object scan and await the customer coming to the point-of-sale system to present the object or take some other action to complete the transaction.

Thus, in these ways, the systems and methods herein can be implemented for checkout assistance or loss prevention verification. For example, when problems are detected at a self-checkout SCO, an imager of a user interface device could trigger a remote customer service session where two-way video communication could take place. The user interface device could provide a remote customer service agent with identification of items in order to aid in the verification that all the items have been properly scanned. For instance, if scan avoidance is detected by the system, the remote customer service agent could ask the customer to rescan the items in the bag which were missed or take other appropriate action. The system could be configured to show the customer a video clip of when the scan avoidance or ticket switching event captured in the image data of the user interface device.

While in the examples of FIGS. 2 and 4, configurations are shown with a user interface device being separate from and connected to a media processing device through a communication link, in other examples, a user interface device may be single integrated unit that includes a media processing device. FIG. 6, for example, illustrates a user interface device 600 that provides any of the methods and operations described herein, and includes, in addition to a processor 602, memory 604, and imager 606, a media processing device 608 that includes both a display 610 and a printer 612.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system comprising:
an imaging camera having a field of view (FOV);
a media processing device;
a housing having a display and positioning the imaging camera; and
a processor configured to;
obtain image data captured from the imaging camera and detect a presence of an object in the image data;
in response to failing to obtain a presence of a decodable indicia for the object;
perform an object identification process from the image data to determine object identification data;
communicate the object identification data to an object identification module with a request for object indicia data corresponding to the object identification data, and
in response to receiving the object indicia data from the object identification module, communicate a media processing instruction to the media processing device communicatively coupled to the processor,
wherein the media processing device is configured to process media for the object, the media including the object indicia data, in response to receiving the media processing instruction from the processor.

2. The system of claim 1, wherein the processor is further configured to:
display instructions for applying the media to the object.

3. The system of claim 2, wherein the processor is further configured to:
display an indication on display for confirmation of placement of the media on the object;
obtain subsequent image data captured from the imaging camera and detect, in the subsequent image data, a presence of the media on the object; and
in response to failing to detect a presence of the media on the object, generating a failed object scan indication.

4. The system of claim 3, wherein the processor is further configured to: communicate the failed object scan indication to a supervisor computing system or a point-of-sale computing system.

5. The system of claim 1, wherein the object indicia data includes a decodable indicia corresponding to the object identification data and (i) a picture of a representative object corresponding to the object identification data, (ii) user readable information corresponding to the object identification data, (iii) user readable operating instructions corresponding to the object identification data, (iv) machine readable information corresponding to the object identification data, and/or (v) machine readable operating instructions corresponding to the object identification data.

6. The system of claim 1, wherein the processor is further configured to:
detect in the image data captured from the imaging camera a user identification data; and
include with the media processing instruction to the media processing device the user identification data, wherein the media processing device is configured to process the media for the object, the media including the object indicia data and the user identification data.

7. The system of claim 1, wherein the media processing device is a printer.

8. The system of claim 1, wherein the processor is further configured to examine the image data for a presence of the decodable indicia on the object.

9. The system of claim 1, wherein the processor is further configured to receive a user input of the decodable indicia on the object.

10. A system comprising:
a mountable user interface device comprising:
an imaging camera having a field of view (FOV);
a housing having a display, the housing positioning the imaging camera to extend the FOV in front of the display; and
a first processor configured to;
obtain image data captured from the imaging camera and corresponding to the FOV,
detect a presence of a user in the image data and determine user data identifying the user and/or detect a presence of an object in the image data and determine object data identifying the object,
determine, from the user data and/or from the object data, routing data, and
communicate the routing data to an external computing system over a communication network; and
the external computing system communicatively coupled to the mountable user interface device via the communication network, the external computing system comprising:
a second processor configured to:
in response to receiving the routing data, determine an object specific data service and/or a user specific data service;
configure the object specific data service and/or the user specific data service based on the routing data; and
communicate the configured object specific data service and/or the configured user specific data service to the first processor of the mountable user interface device;
the first processor further configured to:
in response to receiving the configured object specific data service and/or the configured user specific data service, displaying the configured object specific data service and/or the configured user specific data service on the display.

11. The system of claim 10, wherein the object specific data service and/or the user specific data service comprises a remote user service session with an operator associated with the external computing system.

12. The system of claim 11, wherein the second processor is further configured to configure the object specific data service and/or the user specific data service based on the routing data by assigning the operator among a plurality of operators based on the user data.

13. The system of claim 10, wherein the second processor is further configured to configure the object specific data service and/or the user specific data service based on the routing data by assigning the operator among a plurality of operators based on the object data.

14. The system of claim 10, wherein the object specific data service and/or the user specific data service comprises a predetermined video, image, or message.

15. The system of claim 10, wherein the first processor is further configured to:
instruct the imaging camera to capture the image data in response to a failed object scan event.

16. The system of claim 10, wherein the failed object scan event is detected at an Imaging station of transaction computing device communicatively coupled to the system, and wherein the first processor is further configured to:
capture subsequent image data at the imaging camera;
detect a successful object scan event at the imaging camera; and
communicate the successful object scan event to the transaction computing device.
